(19) United States
(12) Patent Application Publication
(10) Pub. No.: US 2002/0043557 A1
(43) Pub. Date: Apr. 18, 2002

(54) Remote controller, mobile phone, electronic apparatus, and method of controlling the electrical apparatus

(76) Inventors: Tetsuya Mizoguchi, Hino-shi (JP); Masao Suga, Ome-shi (JP)

Correspondence Address: Finnegan, Henderson, Farabow, Garrett & Dunner, L.L.P., 1300 I Street, N.W., Washington, DC, 20005-3315, US

(21) Appl. No.: 09/897,996

(22) Filed: Jul. 5, 2001

(30) Foreign Application Priority Data
Jul. 5, 2000 (JP) 2000-204128

(51) Int. Cl. G06F 17/00

(52) U.S. Cl. 235/375

(57) ABSTRACT

According to the present invention, there is provided a remote controller capable of remarkably expanding the application of an IC card without increasing costs. The remote controller comprises a memory interface connected to the data section of the IC card when a memory chip is installed, a memory control section capable of reading and writing the data from and into the data section, a remote control circuit connected to the memory control section, a system control section for controlling the memory interface, memory control section, and remote control circuit, and means for, before sending a control signal, transmitting its own identification information or identification information about the IC card to a television set acting as a controlled device.

### CROSS-REFERENCE TO RELATED APPLICATIONS

This application is based upon and claims the benefit of priority from the prior Japanese Patent Application No. 2000-204128, filed Jul. 5, 2000, the entire contents of which are incorporated herein by reference.

### BACKGROUND OF THE INVENTION

This invention relates to a remote controller which is useful as a remote control device that permits installation and removal of a large-capacity IC card and which, together with a device to be controlled, achieves valuable uses, and to a mobile phone and an electronic apparatus, and to a method of controlling the electronic apparatus.

In recent years, there have been editing devices with a display function which have a card slot therein and enable an IC card, carrying digital pictures taken by a digital camera, to be inserted into the card slot. With this configuration, they enable the digital pictures to be edited.

Since such editing devices use the technique of inserting an IC card into the editing device, the type and shape of the IC card used are limited.

Furthermore, when an IC card is inserted into a television set to display the image data recorded on the IC card, the type and shape of the IC card used are limited. This puts a limit on the application of television sets or that of external storage mediums.

As described above, when a slot is made in the editing device or the television set to use a conventional IC card, the editing device or television set cannot deal with various types or shapes of the storage medium. An attempt to provide various slots and installing sections in the editing device or television set would increase costs significantly.

### BRIEF SUMMARY OF THE INVENTION

It is, accordingly, an object of the present invention to provide a remote controller capable of not only remarkably expanding the application of an IC card without increasing costs, but also remarkably improving the application of a remote controller according to the present invention.

The foregoing object is accomplished by providing a remote controller for remotely controlling the operation of an electronic apparatus, comprising: a card slot which permits installation and removal of an IC card; reproducing means for reading data from the IC card inserted into the card slot; and transmission means for transmitting information about the type of the IC card reproduced by the reproducing means.

This configuration enables the remote controller to be used in various ways by replacing the present IC card with an IC card with different content. It also enables various types of device to be used as a controlled device (or an electronic apparatus).

A remote controller of the present invention further comprises a wireless terminal section to which a transmission/reception unit can be connected so that the content of the IC card may be transmitted to a controlled device or that the content from the controlled device may be received, recorded, or reproduced.

This configuration enables a card or Bluetooth unit, incorporating a transmitting/receiving function, to be installed into the wireless terminal section. The user can then receive the content from a television set, a VTR, a DVD, or a CD and enjoy music or movies in remote control. Conversely, the music recorded in the IC card can be sent to a controlled device for the user to listen to it.

Furthermore, a remote controller of the present invention further comprises reproducing means for reading image data from the IC card inserted into the card slot and transmission means for transmitting the image data read by the reproducing means to the electronic apparatus.

This configuration enables the picture data picked up by, for example, a digital camera to be read from an IC card and sent to a display unit for editing. When many IC cards are used, the IC card can be replaced with another at hand, assuring a good working efficiency.

A remote controller of the present invention further comprises transmission instructing means for instructing the electronic apparatus to transmit data, a wireless terminal for responding to the transmission instruction from the transmission instructing means and receiving the data transmitted by the electronic apparatus, recording means for recording the data received via the wireless terminal into the IC card inserted in the card slot, and reproducing means for reproducing the data recorded in the IC card.

This configuration enables the user to enjoy the music information sent from the electronic apparatus (e.g., a television set, VTR, DVD, or CD) at hand. Use of a display section enables the user to enjoy video information at hand.

A remote controller of the present invention further comprises transmission instructing means for instructing the electronic apparatus to transmit data, a wireless terminal for, on the basis of the transmission instruction, receiving the data encrypted on the basis of the unique ID information stored in the remote controller and electronic apparatus, and recording means for recording the encrypted data into the IC card inserted in the card slot.

This configuration increases secrecy in the transmission and reception of the content, which improves the reliability of the use of the device.

Furthermore, according the present invention, there is provided a mobile phone for remotely controlling the operation of an electronic apparatus, comprising: a card slot which permits installation and removal of an IC card; means for reproducing a control program for controlling the body of the electronic apparatus from the IC card inserted in the card slot; control means for remotely controlling the electronic apparatus on the basis of the reproduced control program; reception means for receiving the data transmitted on the basis of a request made by the remote control means to the electronic apparatus for transmission of data; recording means for recording the received data into the IC card inserted in the card slot; and reproducing means for reproducing the data recorded in the IC card.

This configuration enables the application of the mobile phone to be expanded and the information from the mobile phone to be transferred to a controlled device (or electronic apparatus).

In addition, according to the present invention, there is provided an electronic apparatus controlled by a remote controller permitting installation and removal of an IC card, comprising: a wireless terminal for receiving the data the remote controller has stored in the IC card; judging means for judging the type of the IC card from the data transmitted via the wireless terminal; and reproducing means for reproducing the received data on the basis of the result of the judgment at the judging means.

Still furthermore, according to the present invention, there is provided a controlled device controlled by portable remote control means permitting installation and removal of an IC card, comprising identifying means capable of identifying the type of the IC card from the signal transmitted from the portable remote control means.

This configuration enables the controlled device to be controlled according to the type of IC card.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an example of the usage of a remote controller to which the present invention is applied;

FIG. 2 is a block diagram showing the internal configuration of a television set of FIG. 1;

FIG. 3 is a diagram to help explain the data structure of a chip memory;

FIG. 4 is a diagram to help explain an example of the kinds of contents of the chip memory;

FIG. 5 is a flowchart to help explain an example of the operation of the television set of FIG. 1;

FIG. 6 is a flowchart to help explain another example of the operation of the television set of FIG. 1;

FIG. 7 shows another example of the usage of the remote controller to which the present invention is applied;

FIG. 8 shows another example of the remote controller to which the present invention is applied;

FIG. 9 shows still another example of the remote controller to which the present invention is applied;

FIG. 10 shows still another example of the remote controller to which the present invention is applied;

FIG. 11 shows still another example of the remote controller to which the present invention is applied;

FIG. 12 is a block diagram showing the internal configuration of a remote control according to the present invention;

FIG. 13 is another block diagram showing the internal configuration of a remote control according to the present invention;

FIG. 14 is still another block diagram showing the internal configuration of a remote control according to the present invention;

FIG. 15 is still another block diagram showing the internal configuration of a remote control according to the present invention;

FIG. 16 is still another block diagram showing the internal configuration of a remote control according to the present invention;

FIG. 17 is still another block diagram showing the internal configuration of a remote control according to the present invention;

FIG. 18 shows an example of the usage of a remote controller according to the present invention;

FIG. 19 is a flowchart to help explain an example of the operation of the remote controller according to the present invention;

FIG. 20 is a flowchart to help explain another example of the operation of the remote controller according to the present invention;

FIG. 21 is a flowchart to help explain still another example of the operation of the remote controller according to the present invention; and

FIG. 22 is a flowchart to help explain still another example of the operation of the remote controller according to the present invention.

### DETAILED DESCRIPTION OF THE INVENTION

Hereinafter, referring to the accompanying drawings, embodiments of the present invention will be explained.

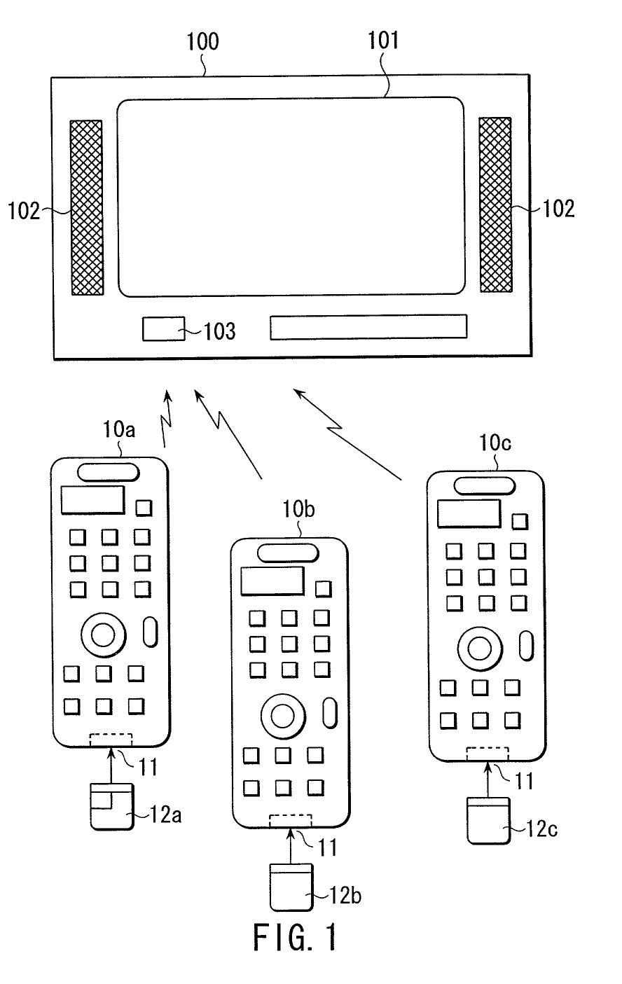

FIG. 1 schematically shows a remote controller to which the present invention is applied and a television set serving as an electronic apparatus (a controlled device) remotely controlled by the remote controller.

In this example, a plurality of remote controllers 10a, 10b, and 10c can each control a television set 100 remotely. When the remote controllers are generically referred to, they are indicated by numeral 10 and represented as remote controller 10.

The television set 100 includes a display section 101, a sound output section 102, and a transmission/reception section 103 for receiving a remote control signal or transmitting a signal to the remote controller 10.

The remote controller 10 includes an IC card installing section 11 serving as a card slot. The IC card installing section 11 permits installation and removal of IC cards (memory chips) 12a, 12b, and 12c. When the IC cards 12a, 12b, 12c in FIG. 1 are generically referred to, they are represented as an IC card 12 for the sake of simplicity.

While in FIG. 1, an IC card 12 is inserted into or removed from the slot-type IC card installing section 11 from behind the remote controller 10, it may be installed and removed in other various ways. For instance, a lid may be provided to the remote controller 10 and an IC card 12 be installed into or removed from the lidded compartment.

The remote controller 10 has a control section for remotely controlling a controlled device (in FIG. 1, the television set 100), in which a plurality of control keys are arranged. The example of FIG. 1 is illustrative and not restrictive.

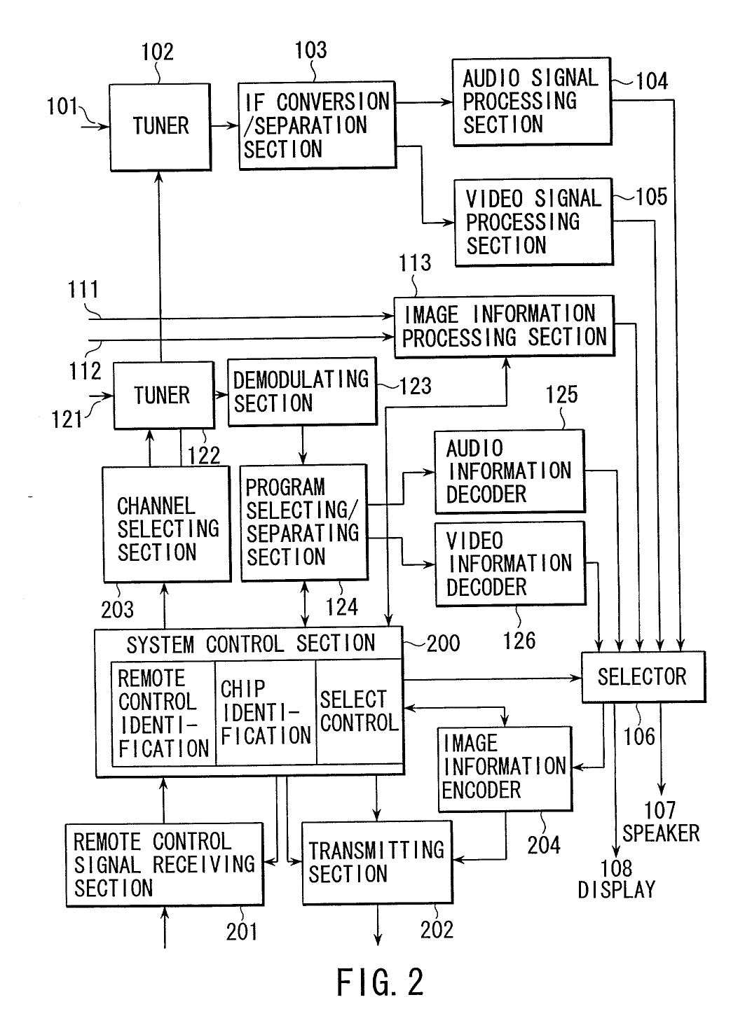

A block diagram of the television set 100 will be explained by reference to FIG. 2.

A VHF/UHF receiving antenna is connected to a tuner input terminal 101. The signal received via the antenna is directed to a tuner 102. The tuner 102 selects a particular channel. The high-frequency signal of the selected channel is directed to an intermediate frequency (IF) conversion/separation section 103. The IF conversion/separation section 103 frequency-converts the high-frequency signal and then separates the converted signal into an audio signal and a video signal. The audio signal is directed to an audio signal processing section 104 and the video signal is directed to a video signal processing section 105. Each of the audio signal and video signal is converted from the intermediate-frequency signal into a baseband signal, which is then supplied to a selector 106.

It is assumed that the selector 106 has selected the output of the audio signal processing section 104 and the output of the video signal processing section 15. Then, the audio signal is outputted to a speaker connect section 107 and the video signal is outputted to a display connect section 108.

Input terminals 111 and 112 are for supplying a DVD video output and a VTR video output, respectively. The signals inputted to these terminals are directed to an image information processing section 113. The image information processing section 113 subjects the video signal to aspect ratio adjustment, format conversion, or picture-quality adjustment, as the need arises. The output of the image information processing section 113 is supplied to the selector 106. The processing system for the DVD and VTR audio outputs is not shown in FIG. 2. The selector 106 selects the input according to the control signal from a system control section 200 explained later and directs the selected input to the speaker connect section 107 and display connect section 108.

An input terminal 121 is a terminal to which a digital broadcast signal is directed. The digital broadcast signal is directed via the input terminal 121 to a tuner 122. The signal selected by the tuner 122 is directed to a demodulating section 123, which subjects the signal to QPSK demodulation. The demodulated signal is a packet stream. The stream is supplied to a program selecting/separating section 124. On the basis of the program select information from the system controller 200, the program selecting/separating section 124 extracts the packets of the program specified by the user. The audio packets are inputted to an audio information decoder 125, which decodes the audio packets. The video packets are inputted to a video information decoder 126, which decodes the video packets according to, for example, the MPEG-2 standard.

The audio signal outputted from the audio information decoder 125 and the video signal outputted from the video information decoder 126 are inputted to the selector 106. It is assumed that the selector 106 has selected the output of the audio information decoder 125 and that of the video information decoder 126. Then, the speaker outputs the sound of the digital broadcast program selected by the user. The display unit displays the pictures of the digital broadcast program selected by the user.

The system control section 200 is for controlling all the blocks of the television set 100 and includes the function of communicating with a remote control unit (or remote controller 10). It also includes encrypting means for encrypting the transmission information and decrypting means for decrypting the reception information.

A remote control signal receiving section 201 and a transmitting section 202 for sending a signal to the remote controller 10 are connected to the system control section 200. When receiving a channel select signal from the remote controller 10, the system control section 200 decrypts the signal and controls a channel selecting section 203. This control determines the selected channel for the tuner 102 of 122. In receiving digital broadcast, the system control section 200 controls the program selecting/separating section 124 on the basis of the program select information sent from the remote controller 10. By this control, the packets that carry the program information specified in the stream is extracted.

Furthermore, the system control section 200 can control an image information encoder 204. By this control, the image information encoder 204 can convert the image information outputted from the selector 106 into a specific format and supply the converted information to the transmitting section 202. The image information encoder 204 includes a buffer memory for temporarily storing image data, such as a frame memory.

The system control section 200 further includes the function of decrypting the signal received from the remote control signal receiving section 201 and identifying the remote controllers 10a, 10b, and 10c as shown in FIG. 1 (or a remote control identifying function). The system control section 200 also includes the function of decrypting the signal received from the remote control signal receiving section 201 and identifying the IC cards 12a, 12b, and 12c as shown in FIG. 1 (or a chip identifying function).

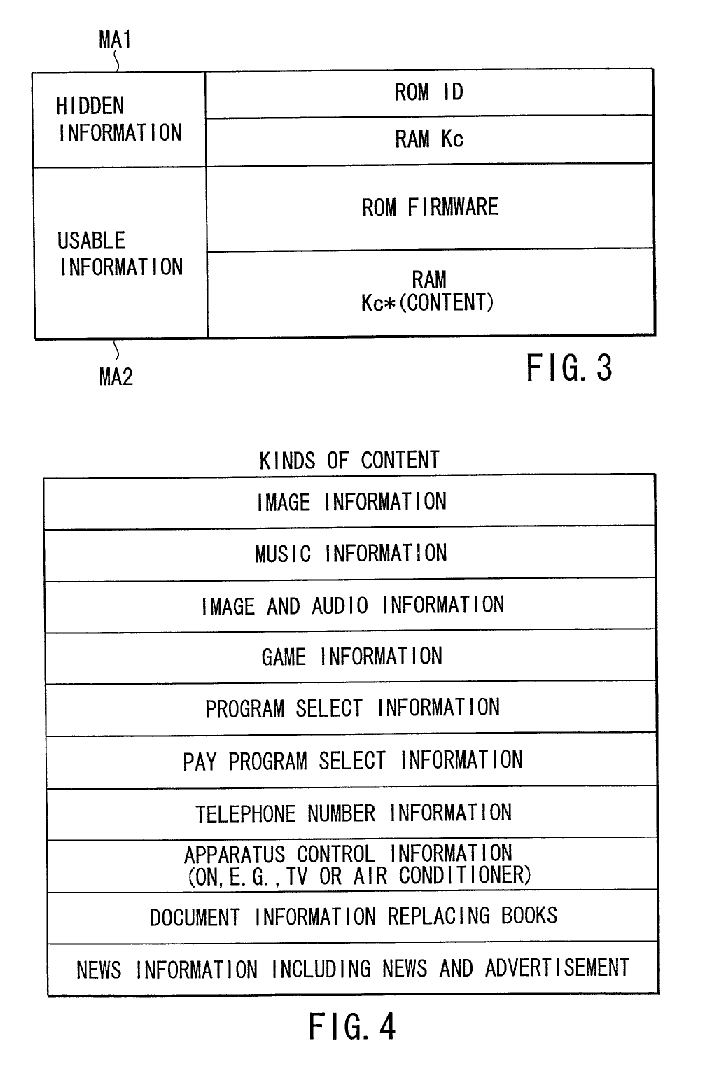

FIGS. 3 and 4 show an example of the data structure of the IC card.

The IC card 12 includes an area MA1 for hidden information externally unreadable and an area MA2 for information externally readable and usable. In area MA1, ROMID acting as identification information for the IC card 12 and key Kc for decrypting the encrypted content or encrypting the content have been written. In area MA2, firmware, or the control data, necessary for the CPU to read the information from the IC card 12 and perform data processing, and content (including music, video, remote control information, and delivery information) have been written.

FIG. 4 shows various types of information as the content, which is illustrative and not restrictive. Typical content includes image information, music information, image and music information, game information, program select information, pay program select information, telephone number information, apparatus control information (including television, air conditioner, audio apparatus, and DVD), document information replacing books, and news information including news and advertisements.

Although now shown, photograph information (image information) taken by a digital camera may be stored. Then, the remote controller 10 transfers the information to the television set 100, which displays the photograph information.

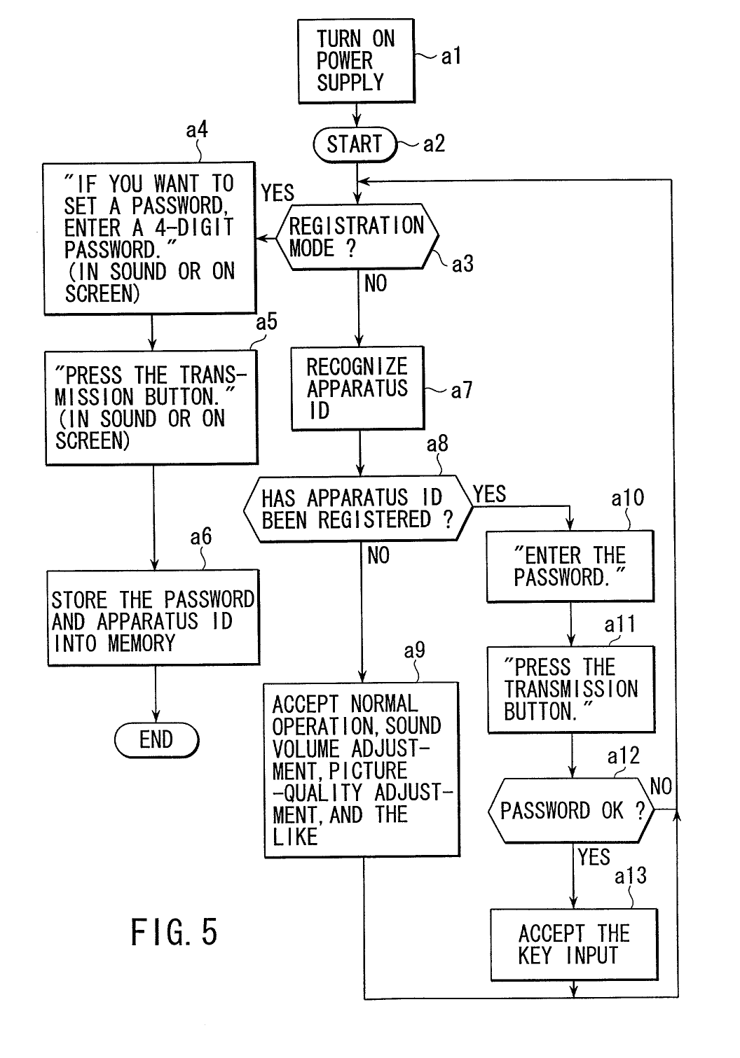

FIG. 5 shows the approach of enabling the system control section 200 to recognize the remote controller 10. When the power supply of the television set 100 is turned on, the function of receiving a remote control signal starts to operate (step a1). Here, it is judged whether the register mode button has been operated on the remote controller 10 and the register mode command has been received (step a2). When the register mode command has been received, the remote controller 10 currently being operated by the user is interpreted as going to be registered as the user's own device.

At this time, the television set 100 asks the user in sound or on screen display as follows: “If you want to set a password, enter a 4-digit password.” (step a4). When the user operates the keys on the remote controller 10 to enter the password, the television set 100 tells the user by sound or by screen display as follows: “Press the transmission button.” (step a5). The message may be “Press the setting button.” When the user operates, for example, the transmission button, the television set 100 stores the password and apparatus ID (the ID previously allocated to the remote controller 10) into a specific area of a memory (step a6).

It is assumed that the register mode button has not been pressed on the remote controller 10. In this case, the apparatus ID is recognized (step a7). It is then judged whether the apparatus ID has already been registered, or whether the password is necessary (step a8). If the password has not been registered, the remote controller 10 will go into the normal operating state (step a9). If the password has been registered, the television set 100 guides the user in sound or on screen display as follows: “Enter the password” (step a10). When the user operates the keys on the remote controller 10 to enter the password, the television set 100 guides the user as follows: “Press the transmission button” (step a11). Next, the system control section 200 of the television set 100 judges whether the password is correct (step a12). If the password is correct, the system control section 200 will accept the remote control information from this time on (step a13). If the password is wrong, control will return to step a3.

As described above, the television set 100 has the function of recognizing the remote controller 10. Therefore, the user can have his own remote controller 10 and control the television set 100 on the basis of his personally purchased IC card 12.

The IC card 12 can have various contents.

For instance, privately shot unique image data may be stored and then viewed on the screen of the television set 100. An IC card in which a novel has been stored in text data form may be purchased and the text data be displayed on the screen for reading. Moreover, an IC card in which music or a story has been stored in the form of sound information may be purchased and the music or story be listened to through the speaker. In addition, an IC card in which game software has been stored may be purchased and the game be enjoyed on the TV screen.

It goes without saying that the apparatus ID of the remote controller 10 capable of controlling the television set 100 has been registered beforehand in the television set 100, before shipment.

The flowchart of FIG. 5 shows a method of, when using the remote controller 10, managing its password and apparatus ID on the television set 100, which is illustrative and not restrictive. For instance, the ID of the IC card may be registered together with its password.

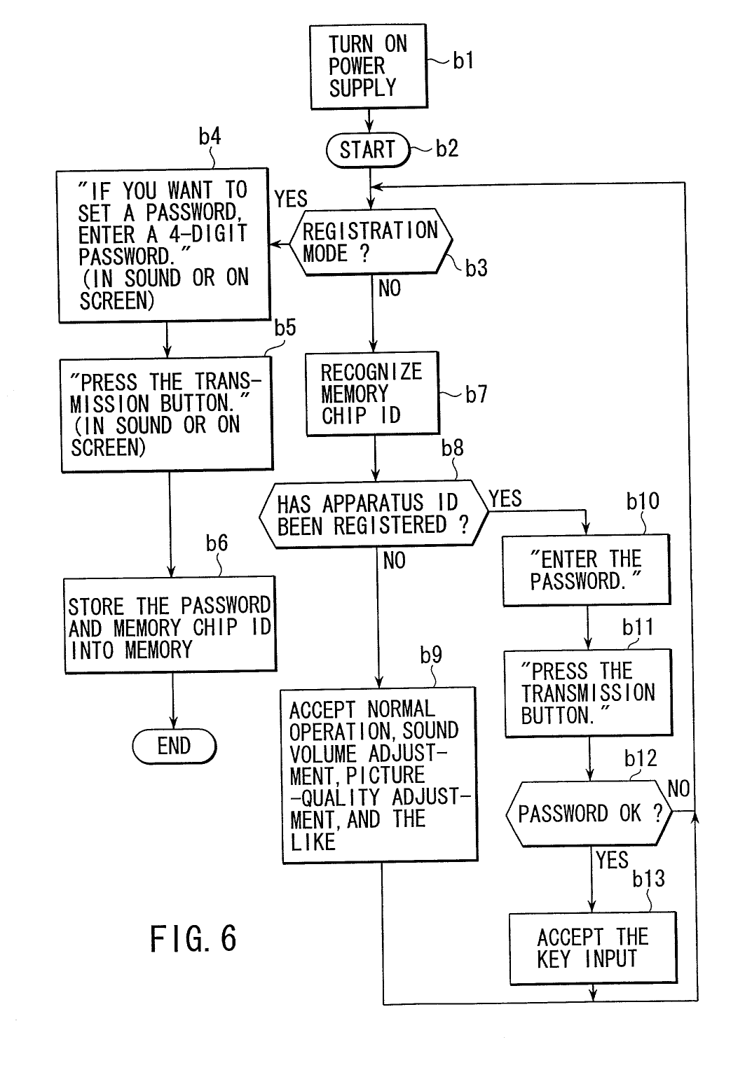

FIG. 6 shows the approach of enabling the system control section 200 to recognize the ID of the IC card installed on the remote controller 10. When the power supply of the television set 100 is turned on, the function of receiving the remote control signal starts to operate (step b1). Here, it is judged whether the register mode button has been operated on the remote controller 10 and the register mode command has been received (step b2). When the register mode command has been received, the ID of the IC card installed on the remote controller 10 currently being operated by the user is interpreted as going to be registered as the user's own IC card.

At this time, the television set 100 asks the user in sound or on screen display as follows: “If you want to set a password, enter a 4-digit password.” (step b4). When the user operates the keys on the remote controller 10 to enter the password, the television set 100 guides the user in sound or on screen display as follows: “Press the transmission button.” (step b5).

When the user operates, for example, the transmission button, the television set 100 stores the password and apparatus ID in a specific area of a memory (step b6).

It is assumed that the register mode button has not been pressed on the remote controller 10 in normal use. In this case, the ID of the IC card is recognized (step b7). It is then judged whether the ID of the IC card has already been registered together with the password (step b8). If the password has not been registered, the remote controller 10 will go into the normal operating state (step b9). If the password has been registered, the television set 100 will guide the user in sound or in words on the screen as follows: “Enter the password” (step b10). When the user operates the keys on the remote controller 10 to enter the password, the television set 100 guides the user as follows: “Press the transmission button” (step b11). Next, the system control section 200 of the television set 100 judges whether the password is correct (step b12). If the password is correct, the system control section 200 will accept the remote control information from this time on (step b13). If the password is wrong, control will return to step b3.

In the above explanation, when the user registers the password in the television set 100, or when the television set 100 requires the user to enter the password, the television set 100 guides the user in sound or in characters on the screen. This way of guidance is illustrative and not restrictive.

For instance, when the remote controller 10 has a receiving function and the television set 100 can transmit guide information as described later, the audio output section or display section of the remote controller 10 may offer guide voice or guide words.

In the embodiment, an individual ID (password) is registered in the television set 100. This way of registration is illustrative and not restrictive. For instance, an individual ID memory for registering an individual ID may be provided in the remote controller 10 and the user's password be registered in the ID memory. In this case, exchange with the television set 100 is not necessary.

Furthermore, the present invention is not limited to the above embodiment.

Since the apparatus ID includes the maker ID and the apparatus unique ID, the apparatus may be remotely controlled by selecting a suitable IC card or replacing the IC card with a suitable one, provided the apparatus (a household electrical appliance, such as a refrigerator, an air conditioner, DVD, VTR, or audio apparatus) has come from the same maker. In this case, the maker ID and IC card ID are used effectively.

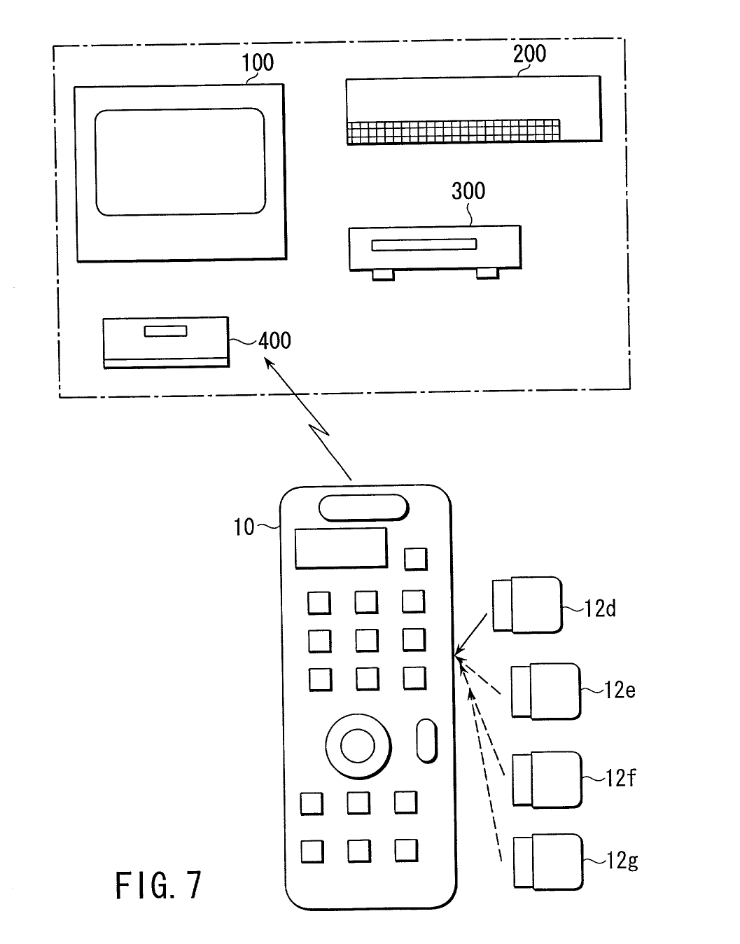

FIG. 7 shows a remote controller 10 capable of remotely controlling any of a television set 100, an air conditioner 301, a VTR 302, and a DVD (CD) player 303.

The remote controller 10 can control any device according to an IC card to be connected. For example, to control the television set 100, a television control IC card 12d is connected to the remote controller 10; to control the air conditioner 301, an air conditioner control IC card 12e is connected to the remote controller 10; to control the VTR 302, a VTR control IC card 12f is connected to the remote controller 10; and to control the DVD 303, a DVD control IC card 12g is connected to the remote controller 10.

In the television control IC card 12d, control information for controlling the television set 100 (such as selecting sound volume, sound, or channel) is stored. It is assumed that the television control IC card 12d is connected to the remote controller 10. When the remote controller 10 transmits the remote control signal (including the maker ID included in the apparatus ID of the remote controller 10 and the IC card ID read from the IC card 12d) to the television set 100, if the maker ID and IC card ID coincide with the maker ID and IC card ID registered in the television set 100, the television set 100 can accept the remote control signal. Even when the same remote controller 10 outputs the remote control signal, the remaining air conditioner 301, VTR 302, and DVD (CD) player 303 do not respond, because their IC card ID differ from the television control IC card ID.

When the IC card 12e for controlling the air conditioner 12e is connected to the remote controller 10, the air conditioner 301 can respond to the remote control signal. In this way, with the present system, changing IC cards enables only one remote controller to control various kinds of household electrical appliances.

Of course, the remote control data items about two or more household electrical appliances may be stored in a single IC card. In this case, a switch for selecting the object to be operated is provided in the control key section of the remote controller 10 in order to switch between the different reading parts of the data area in the IC card.

In the above embodiment, a different type of IC card is selectively installed into the remote controller 10. This method of card installation is illustrative and not restrictive.

For instance, a plurality of IC cards may be installed at the same time into the remote controller 10. In this case, an IC card select button is provided in the control key section of the remote controller 10 so that the desired IC card may function.

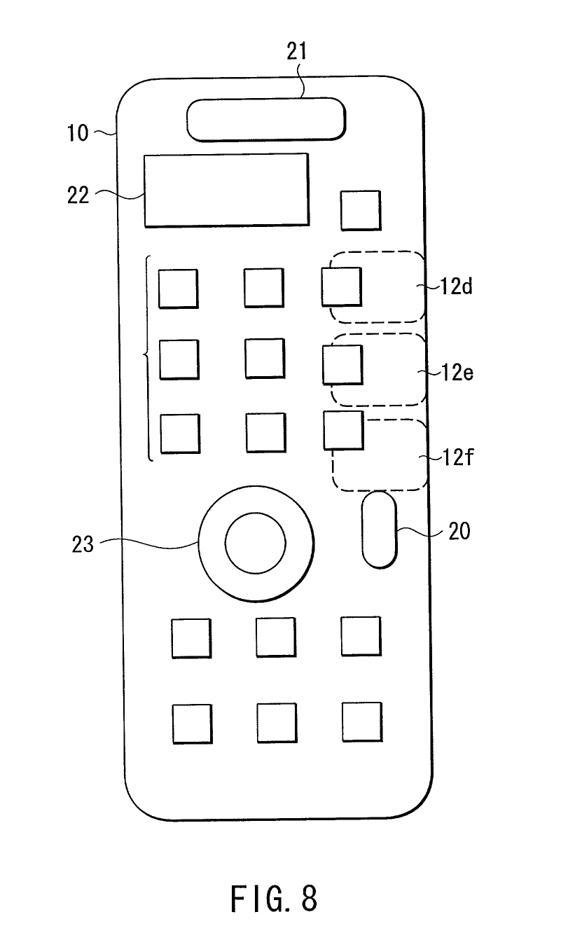

FIG. 8 shows an example of a remote controller 10 designed to enable a plurality of IC cards, for example, 12d, 12e, and 12f, to be installed at the same time. Numeral 20 indicates an IC card select button, which can relate the desired IC card to the body of the remote controller. Numeral 21 indicates a power supply on/off button for a controlled device. Numeral 22 indicates a display section using liquid crystal, which displays, for example, the selected channel or the icon of the controlled object. Numeral 23 indicates a setting button for finally determining, setting, or transmitting the result of the key selection. Numeral 25 indicates a plurality of numerical keys. These keys may be used to display katakana characters, hiragana characters, and the Roman alphabet.

The remote controller 10 is of the type where the display section 22 is formed integrally with the frame, which is illustrative and not restrictive.

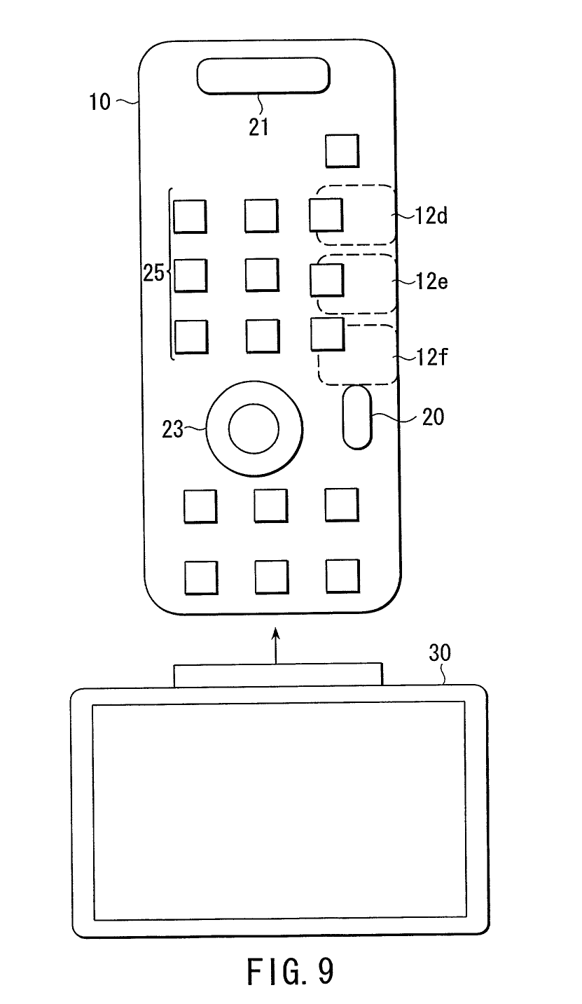

FIG. 9 shows another example of the configuration of the remote controller 10. Specifically, the remote controller 10 is designed to enable a large indicator 30 to be installed into or removed from the controller 10 via a connector. This type of remote controller is effective in enjoining the video information in the contents of the IC card. In FIG. 9, the same parts as those in the above embodiment are indicated by the same reference numerals.

The present invention is not limited to the above embodiment. For instance, most of the control key section of the remote controller 10 may be designed to function as not only a display section but also a control key section.

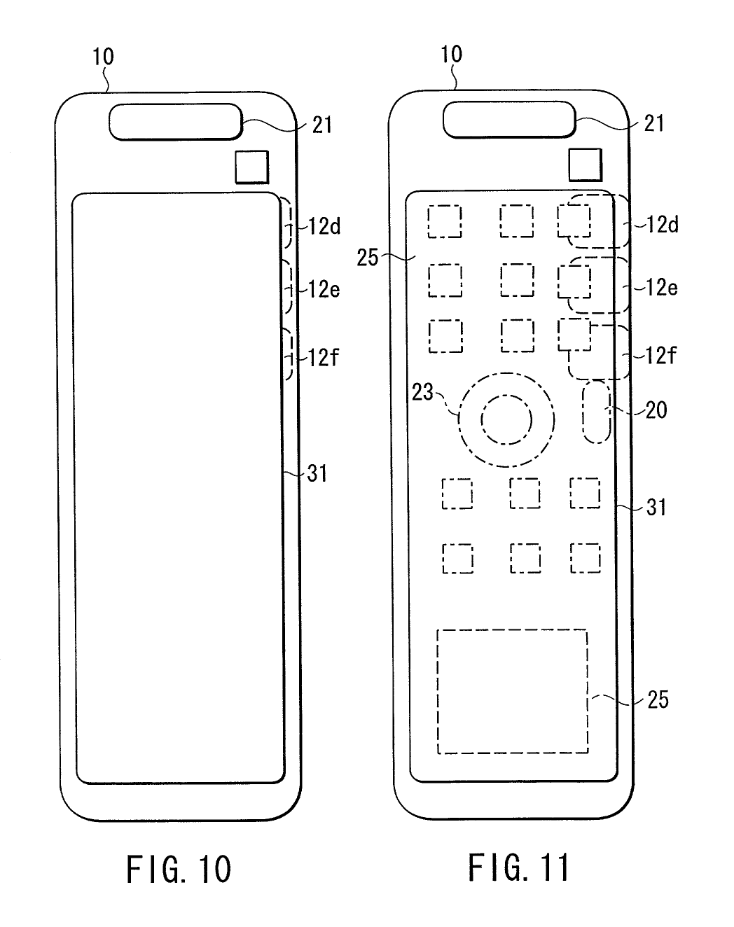

FIG. 10 shows a remote controller 10 with a display and control-key section 31. For instance, when an IC card is connected, the control keys similar to those in the above embodiment appear on the display and control-key section 31. This is because the control key display information has been stored in the contents of the IC card 12. The user can control the controlled device remotely, while looking at the displayed keys. This is realized by the touch panel structure of the display and control-key section 31, which enables the same operation as with the control keys shown in FIGS. 7, 8, and 9. When an air conditioner control IC card is connected or selected, the control keys corresponding to the controlled object appear. A display area 32 corresponding to the display section 22 is secured in a part of the display and control key section 31 of FIG. 11. In FIG. 11, the same parts as those in the above embodiment are indicated by the same reference numerals.

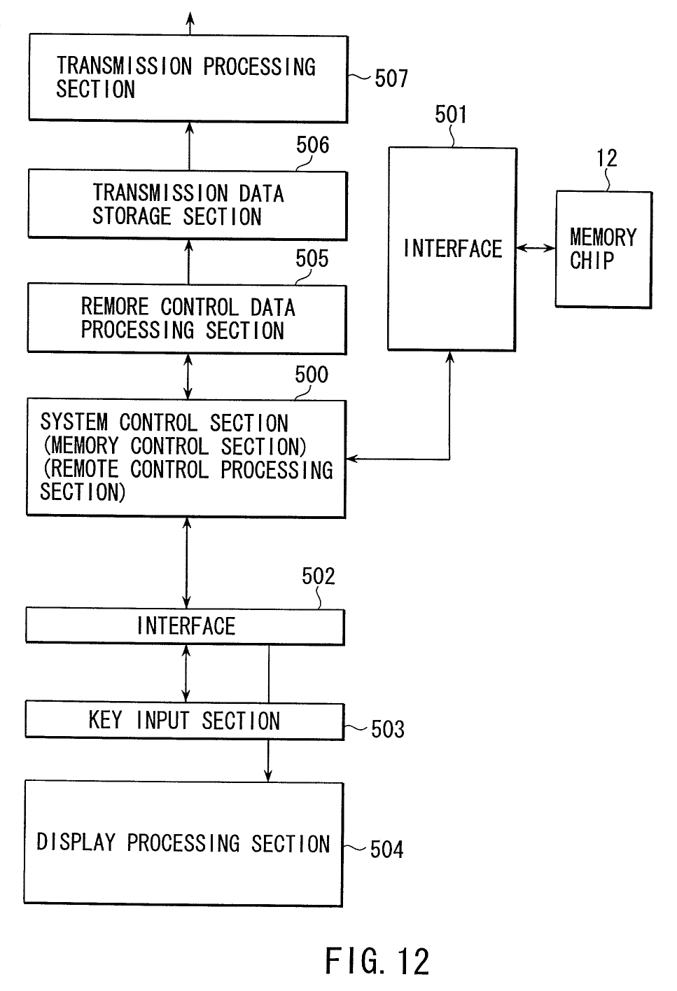

FIG. 12 shows the internal basic functional blocks of the remote controller 10.

Numeral 500 indicates a system control section for controlling the whole remote controller 10, which includes a microcomputer (CPU). An IC card 12 can be connected to the system control section 500 via an interface 501. A key input signal is supplied from a key input section 503 via an interface 502 to the system control section 500. The interface 502 is also connected to a display processing section 504. The display processing section 504 is a circuit for supplying a display signal to the display section 22.

When receiving the key input signal from the key input section 503 via the interface 502, the system control section 500 decrypts the input, controls a remote control data processing section 505, and creates a transmission format there. The remote control data processing section 505 processes the apparatus ID, maker ID, chip ID, and data about the contents of control into those in a format according to the controlled device. Then, the system control section 500 transfers the transmission data to a transmission data storage section 506. The preparation for transmission is then completed. When the user operates a transmission button (or setting button), the stored transmission data is sent to a transmission processing section 507. The transmission processing section 507 modulates the transmission data by a new specific modulation and transmission method and transmits the modulated data. The transmitted data is processed according to the procedure explained in, for example, FIG. 5 or 6.

Although not shown, the remote controller 10 is, of course, provided with a timer circuit for counting year, month, day, and time. It is also provided with a battery serving as a power supply.

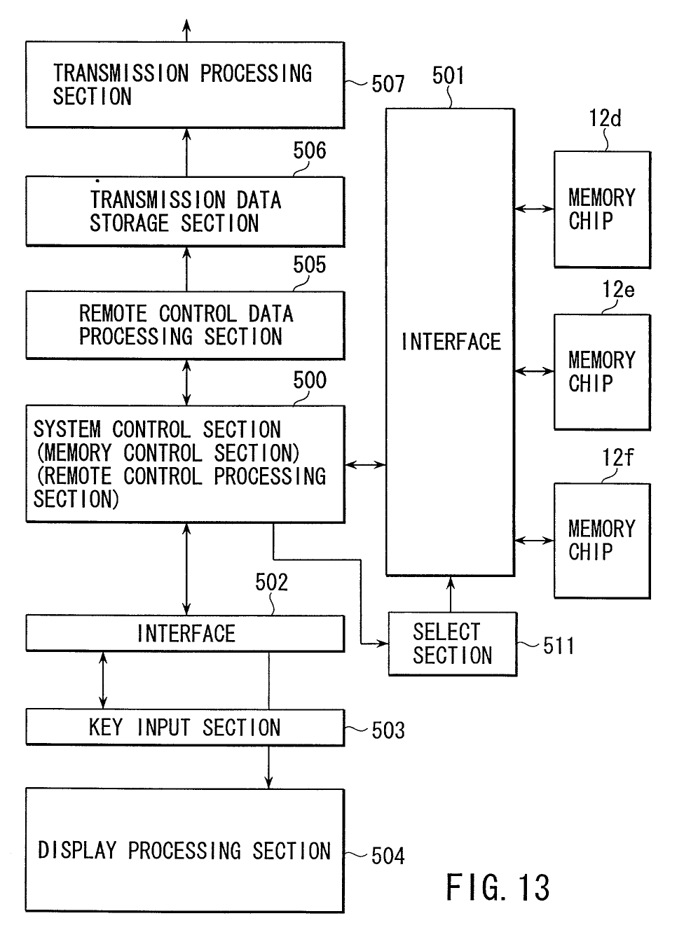

FIG. 13 shows an example of a remote controller 10 designed to enable a plurality of IC cards 12d, 12e, and 12f to be installed at the same time. In FIG. 13, the same parts as those in the above embodiment are indicated by the same reference numerals and explanation of them will be omitted. With the remote controller 10, when the chip select signal is supplied from the key input section 503, the system control section 500 can switch the selecting state of the interface 501 by means of a select section 511. This enables the user to set the desired IC card to the usable state.

With this configuration, for example, pictures taken by a digital camera can be displayed and edited on such a display unit as a television set or a projector. In this case, IC cards may be selected, information may be exchanged or swapped between them, or information may be deleted. Thus, having many IC cards at hand would be useful, as cards could be inserted one after another. Moreover, the user can process the information on the display unit, while checking the pictures on the large screen. In the case of a two-screen television set, by placing the screens side by side for comparison, improvements may easily be made.

In the above embodiment, the remote controller 10 sends the remote control signal in a unidirectional manner, which is illustrative and not restrictive. For instance, the remote controller 10 may be provided with the function of taking in information from an external source.

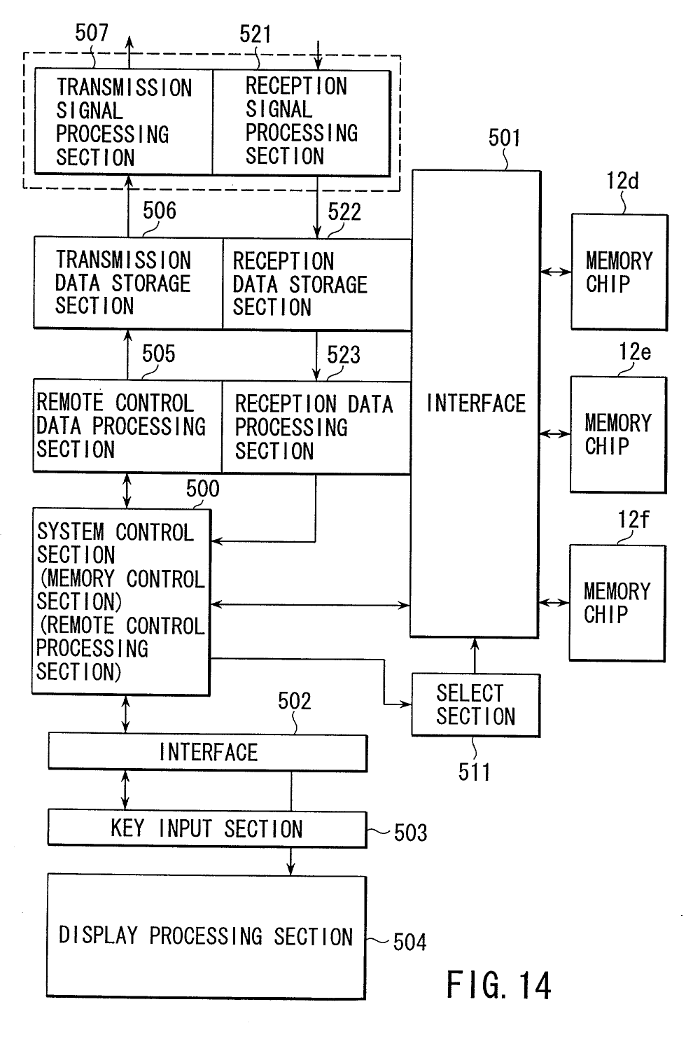

FIG. 14 shows a remote controller 10 including a reception signal processing section 521, a reception data storage section 522, and a reception data processing section 523. The reception signal processing section 521 can receive information from, for example, the transmission section 202 of the television set 100 shown in FIG. 2. The reception signal is demodulated at the reception signal processing section 512 and loaded temporarily into the reception data storage section 522. After all the data have been arranged in the reception data storage section 522, they are transferred to the reception data processing section 523, which recognizes the ID of the apparatus that sent the data and the content (including the display data, audio data, memorable data, and warning data). The recognizing process is carried out under the control of the system control section 500.

For example, the information sent from the television set 100 includes music information, video information, and digital broadcast electronic program information. When taking in the digital broadcast electronic program, the system control section 500 stores it into the IC card 12. Then, it stores the program select information about the program selected by the user into the chip memory 12. It further stores information about the day of the week and time zone that the program select information was used. Such information is accumulated, for example, for more than one week. If more than one piece of program select information exists in the same time zone on the same day of the week, a higher priority will be given to the piece of program select information used for the longest time. In this way, the data is accumulated for, for example, about a month (hereinafter, this data is referred to as user favorite program information). Thereafter, when the user installs the chip memory 12 into the remote controller 10, the system control section 500 reads the user favorite program information. Then, when the user operates the remote controller 100 to receive the digital broadcast, the controller 100 transmits the program select information automatically to the television set 100 on the basis of the user favorite program information.

Since the information obtained from the television set 100 includes character information sent by teletext, the character information can be stored in the IC card 12.

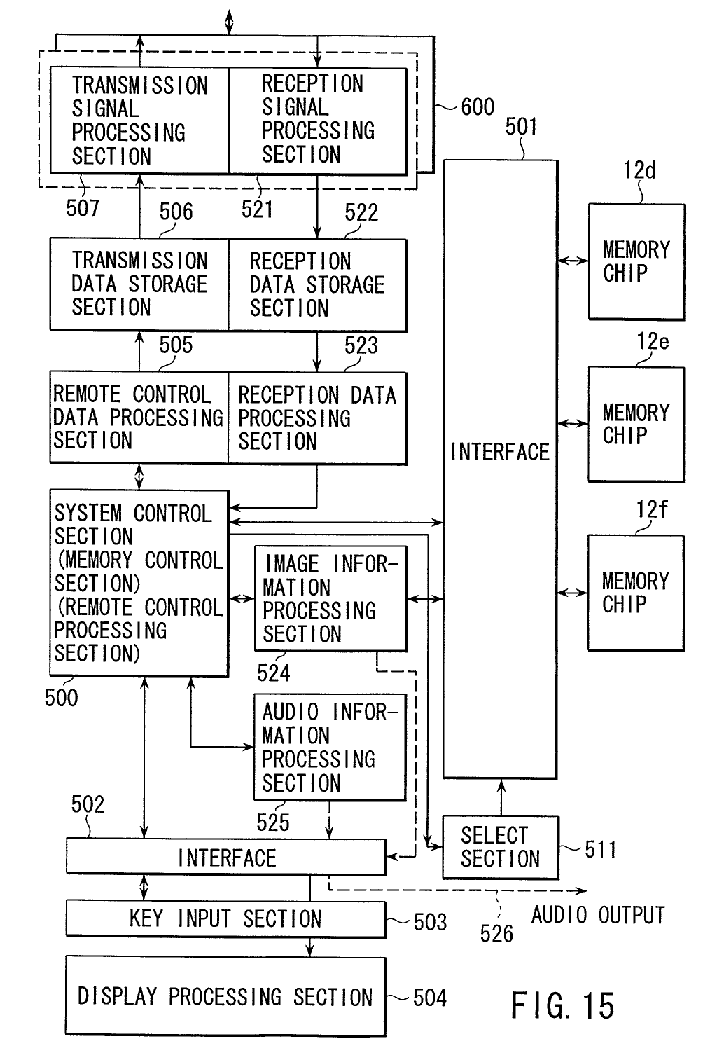

FIG. 15 shows a remote controller 10 with an improved function. In FIG. 15, the same parts as those in the above embodiment are indicated by the same reference numerals. In the remote controller 10, image information processing sections 524, 525 are provided between the system control section 500 and interface 501.

The audio signal may be drawn via the interface 502. An earphone or a speaker may be connected to a terminal 526. Alternatively, the terminal 526 may be designed to be usable with both a speaker and an earphone.

When image information and music information are received from the television set 100, the image information and music information are converted by the image information processing section 514 and audio information processing section 521 into information in a specific recording format. The converted information is stored in the content storage area of the IC card 12.

As described above, when the IC card 12 in which the video information and audio information have been stored is installed in the remote controller 10, the user can enjoy the playback of the video and audio information by operating the remote controller 10. The video information read from the IC card 12 is decoded at the image information processing section 524 and then supplied to the display processing section 504 via the interface 502. This enables the user to enjoy pictures, such as movies, on the display section 22 (FIG. 8), 30 (FIG. 9), or 31 (FIG. 10). At the same time, the audio information read from the IC card 12 is decoded at the audio information processing section 52 and then directed to the terminal 526 via the interface 502. This enables the user to enjoy the sound track of movies through an earphone or speaker.

When the image information processing section 514 and audio information processing section 521 are provided, the information may be transmitted to the television set 100. In this case, encrypting means for encrypting the content and transmitting the encrypted content may be provided. Since pay information is encrypted and transmitted, when such information is viewed or stored into an IC card, means for decrypting the information may be provided. Conversely, when the content stored in the IC card has been encrypted, decrypting means for decrypting the encrypted information may, of course, be provided. There are many encrypting methods. When the remote controller communicates with the television set 100, it is desirable that encrypting should be done using their own IDs (or apparatus IDs).

The present invention is not limited to the above embodiments.

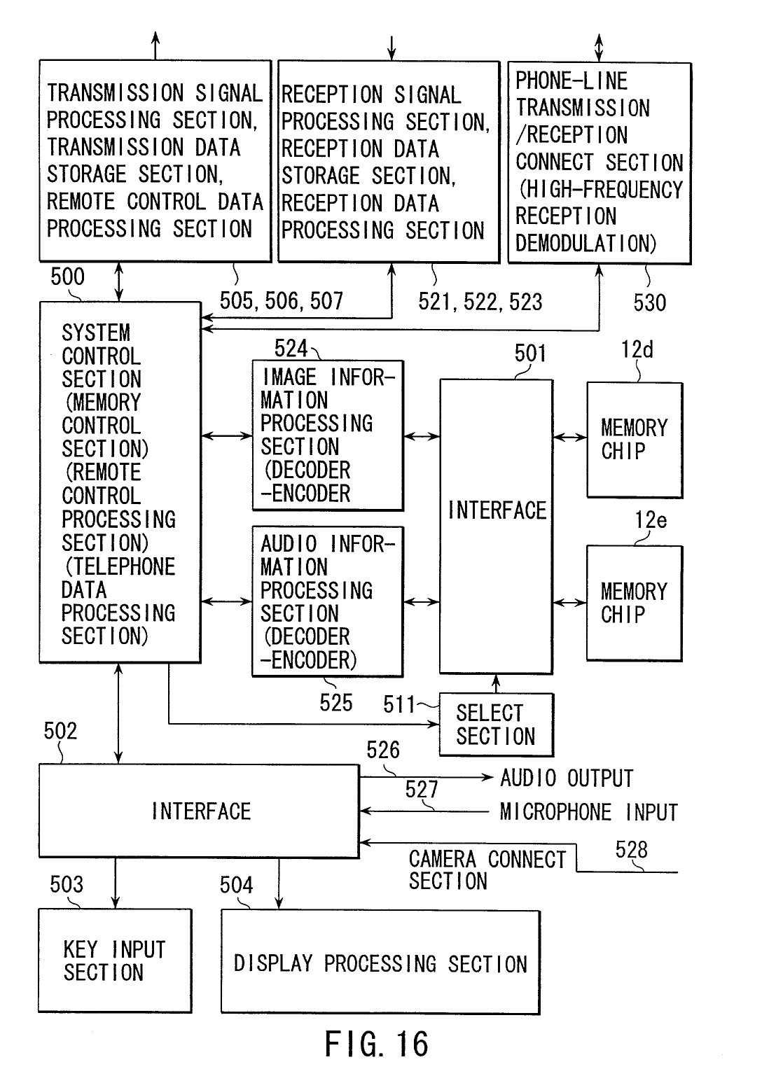

FIG. 16 shows still another embodiment of the remote controller 10. In FIG. 16, the same parts as those in the above embodiment are indicated by the same reference numerals. In the embodiment, a phone-line transmission/reception connect section (connectable to the Internet) 530 is connected to the system control section 500. When being given a telephone number from the system control section 500 according to the key input, the phone-line transmission/reception connect section 530 connects with the other party's apparatus and can communicate with the other party. It can further receive a call from the other party.

The delivery information can be received via a phone line and stored in an IC card. Furthermore, the information stored in the IC card 12 can be decrypted at the image information processing section 524 and audio information processing section 525, displayed on the display section 22, or outputted as sound.

With the above-described configuration, when the device functions as a mobile phone, the display processing section 504 displays, in numerals and icons, various pieces of information used in transmission and reception by a mobile phone. When the device functions as a remote controller, it processes various types of display data items and displays the processed data items on the display section. In this system, to change the function, the IC card may, of course, be replaced with the desired one or the desired IC card be selected to switch the current function to the remote control function, telephone function, audio playback, or video playback.

Furthermore, for example, when the pictures taken by a digital camera have been stored in the IC card 12, the user can transmit the information from the remote controller 10 to the user's friends or relatives via a phone line. The user's friends or relatives can have a similar remote controller 10, receive the transmitted image information, and store it into the IC card 12. Then, they can enjoy reproducing the pictures (image information) on the television set 100, when they want to.

In addition, the remote controller 10 may be provided with an audio output terminal 526, a microphone input terminal 527, and a video camera connect terminal 528. This enables pictures and sound to be recorded and stored.

The present invention is not limited to the above embodiments.

As shown in FIG. 14, a Bluetooth terminal 600 may be provided as signal transmission/reception means for the remote controller 10 side. The transmission and reception of signals according to the Bluetooth standard increases secrecy and the data capacity. This is effective particularly in recording pay programs into the IC card 12 or displaying the pay information stored in the IC card 12 on the screen of the television set 12. Moreover, use of such transmission/reception means is effective in dealing with (transmitting or receiving) copyrighted information.

The present invention is not limited to the above embodiments.

In the above-described remote controller 10, the use of the IC card 12 has been determined beforehand as follows: it is for television set use, for VTR use, or for DVD use. The present invention is not restricted to this.

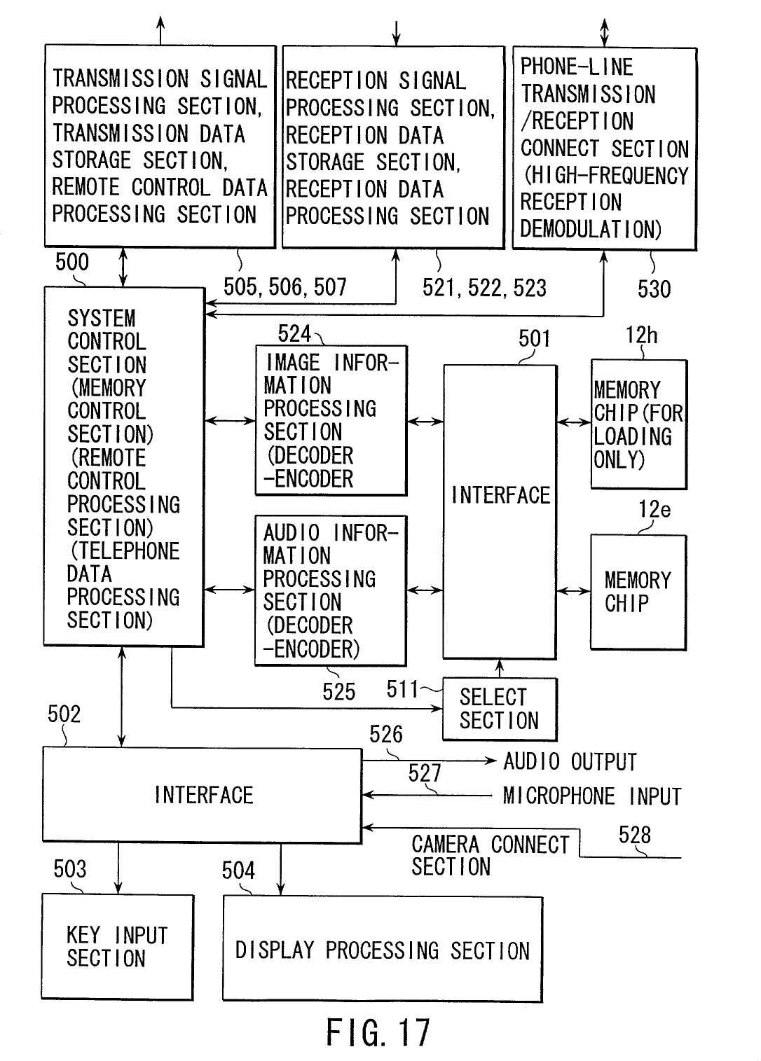

As shown in FIG. 17, when the information is taken in from the phone line or the television set, an IC card 12h exclusively used to take in information may be prepared. That is, the externally taken-in information is loaded automatically into the dedicated IC card 12h. In this case, identification information (ID) is prepared for the load-only IC card 12h. Then, the system control section 500 checks the location of the load-only IC card 12h and sets the card 12h so that it may store the taken-in information. Moreover, not only the load-only IC card 12h but also a spare memory mounting section for a supplementary memory used in case the memory capacity of the card 12h is running short may be provided.

When such a load-only IC card 12h is used, information that has been written in the card can be verified on the display section 22, 30, or 31. To realize this, the system control section 500 itself manages the title of the information written into the IC card 12h. Alternatively, a program for managing the written information may be written as the firmware for the load-only IC card 12h. In this case, when accessing the IC card 12h, the system control section 500 operates on the basis of the write data managing program and functions so as to display the title of the written information.

Although in the above explanation, an IC semiconductor memory is called an IC card, it may be called differently.

The remote controller 10 of the present invention is not limited to the above-described uses. It may also be used as described below.

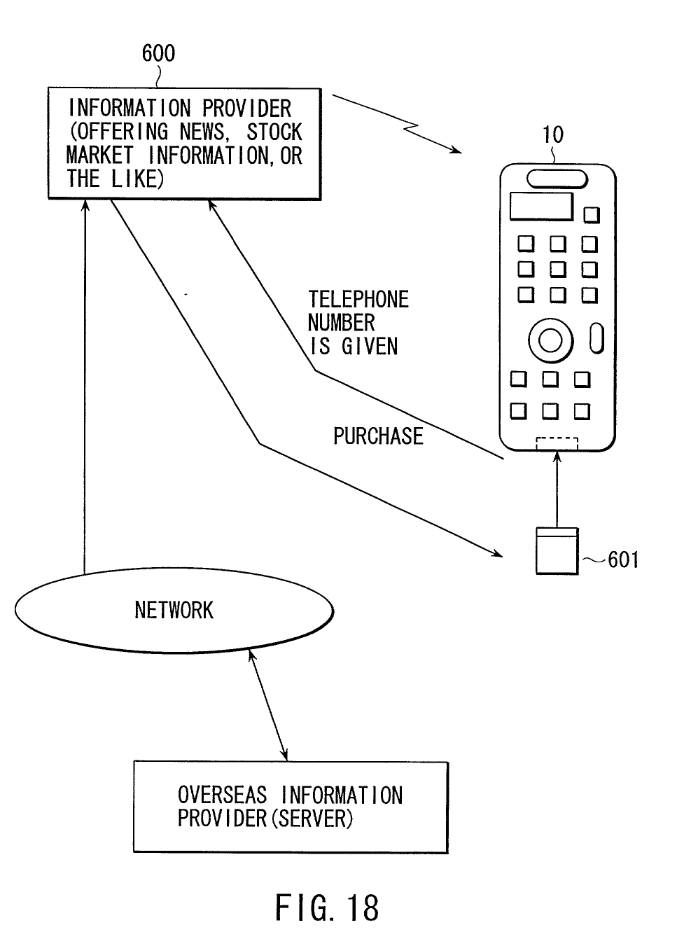

As shown in FIG. 18, for example, it is assumed that an information provider 600 that offers news or stock market information sells IC cards 601. When buying an IC card 601, the user gives the information provider 600 the user's telephone number.

Then, the information provider transmits the information to the user via the phone line every day. The remote controller 10 automatically loads the information taken in from the phone line into the IC card 601 sold by the information provider 600. The IC card 601 has the IC card ID only the information provider knows. In addition to the ID, the IC card 601 has the term of validity written in it.

This enables the remote controller 10 to load today's news or stock market information into the IC card 601 for the term of validity. When the term of validity has expired, an expiration message is displayed when the IC card 601 is installed into the remote controller 10.

The information may be transmitted directly from an overseas information provider or server via a network, or via the information provider 600.

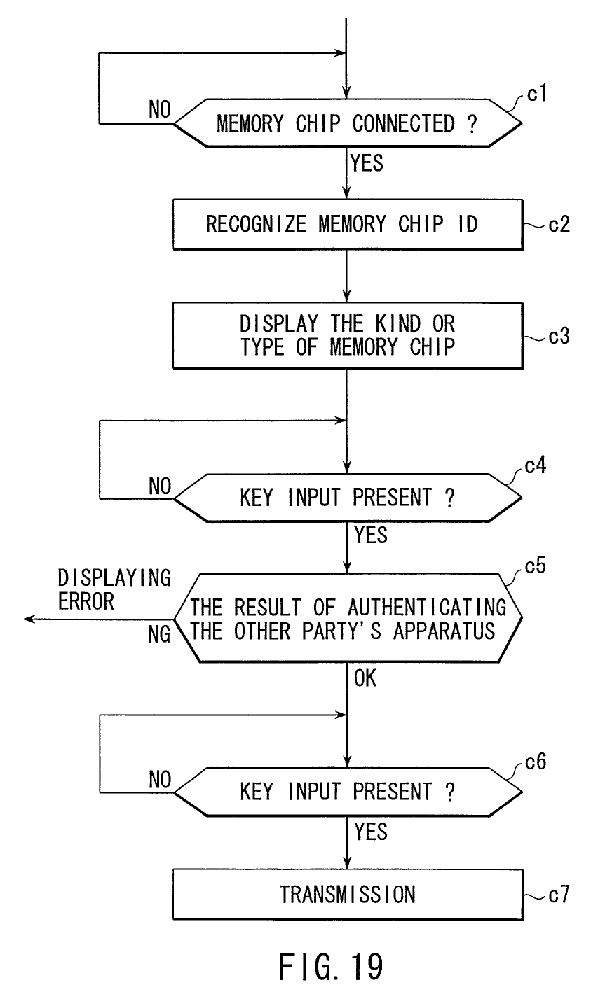

FIG. 19 shows the procedure for the operation of the remote controller 10 when an IC card is connected to the remote controller 10. When the IC card is connected to the remote controller 10 (step c1), the IC card ID is read and checked to see if the ID is valid (step c2). Next, for example, the type of the connected IC card, recording or playback-only use (for music or movie), and remote control (for television, VTR, DVD, or air conditioner) are displayed (step c3). This enables the user to check whether the desired IC card has been installed.

An IC card acknowledge button may be provided on the remote controller 10. Pressing the IC card acknowledge button causes the type of the IC card to be displayed on the display section for a specific period of time. The type of the IC card can be recognized from the IC card ID or the information in its type recording section.

After the type of the IC card has been recognized, the remote controller goes into the key input wait state (step c4). For example, with the IC card for remote control, when the user operates the keys, the remote controller authenticates the other party's apparatus (step c5). This is the process whereby the apparatus ID is authenticated bilaterally. If the authenticating process has shown that the other party's apparatus is the device to be controlled, the remote controller will go into the key input wait state. If the other party's apparatus is not the device to be controlled, an error message will be displayed. When the user operates the keys to perform transmission, the remote controller transmits a remote control signal (steps c6 and c7).

If the installed IC card is used exclusively for playback and its content is image or music information, the image information will be decoded and displayed and the music information be decoded and outputted according to the key input at step c4.

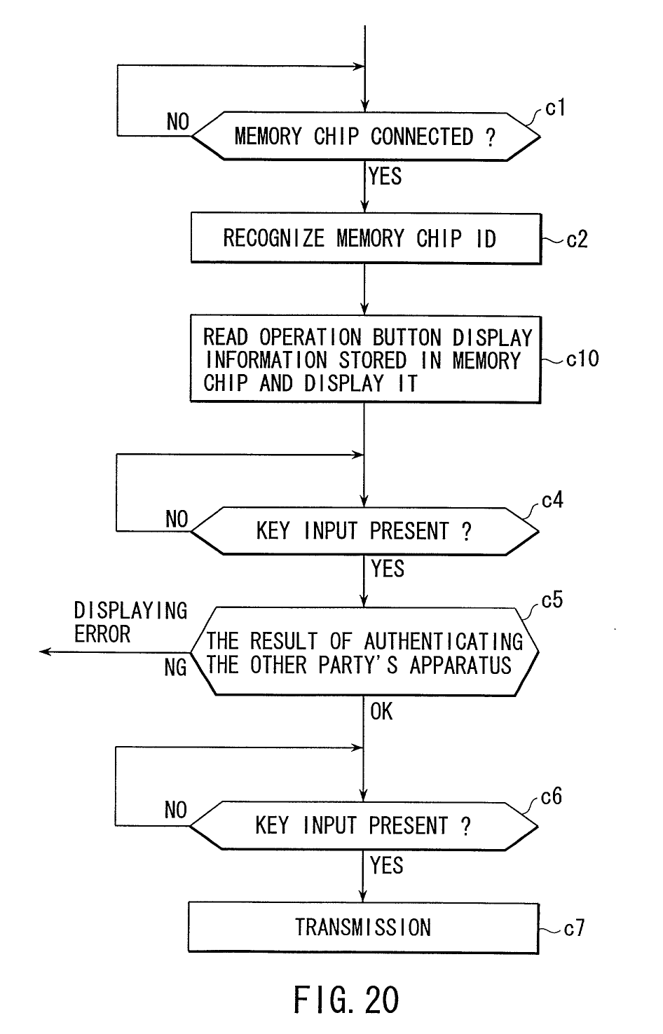

FIG. 20 shows the procedure for the operation of the remote controller 10 when the IC card installed in the remote controller 10 is for remote control and of the type that displays the icons of control buttons on the display section as shown in FIG. 11. What differs from the flowchart of FIG. 19 is that step c10 is present between step c2 and step c4. At step c10, the system control section 200 reads the control button display information recorded in the IC card and then displays it on the display section.

The remaining steps provide the same operations as in FIG. 19, so explanation of them will be omitted.

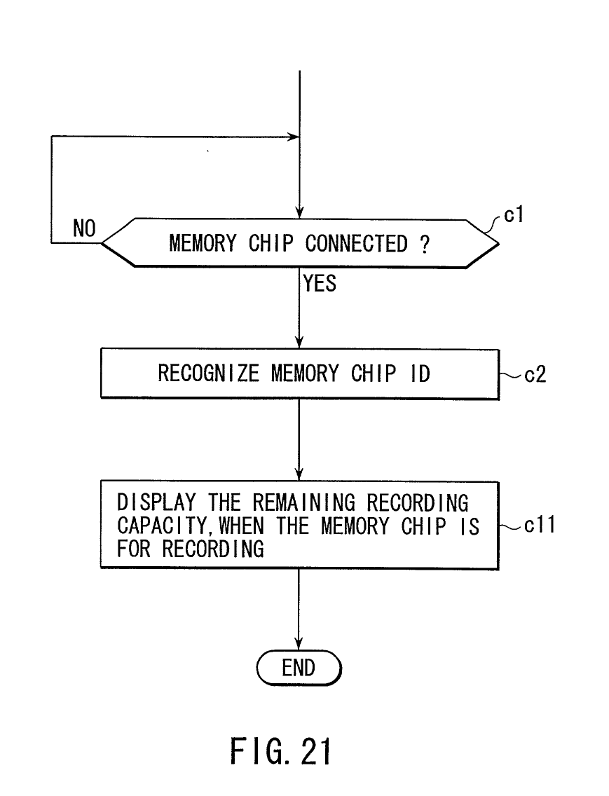

FIG. 21 shows an example of the operation when the IC card installed in the remote controller 10 is used exclusively for recording. In this case, after the IC card has been recognized (step c2), the remaining recording capacity is measured. Then, the remaining recording capacity is displayed (step c11). The function of displaying the recording capacity of the IC card may be allowed to operate when the remote controller 10 is brought into, for example, the program recording wait state. Seeing the remaining recording capacity, the user can replace the IC card or delete unnecessary data from the IC card.

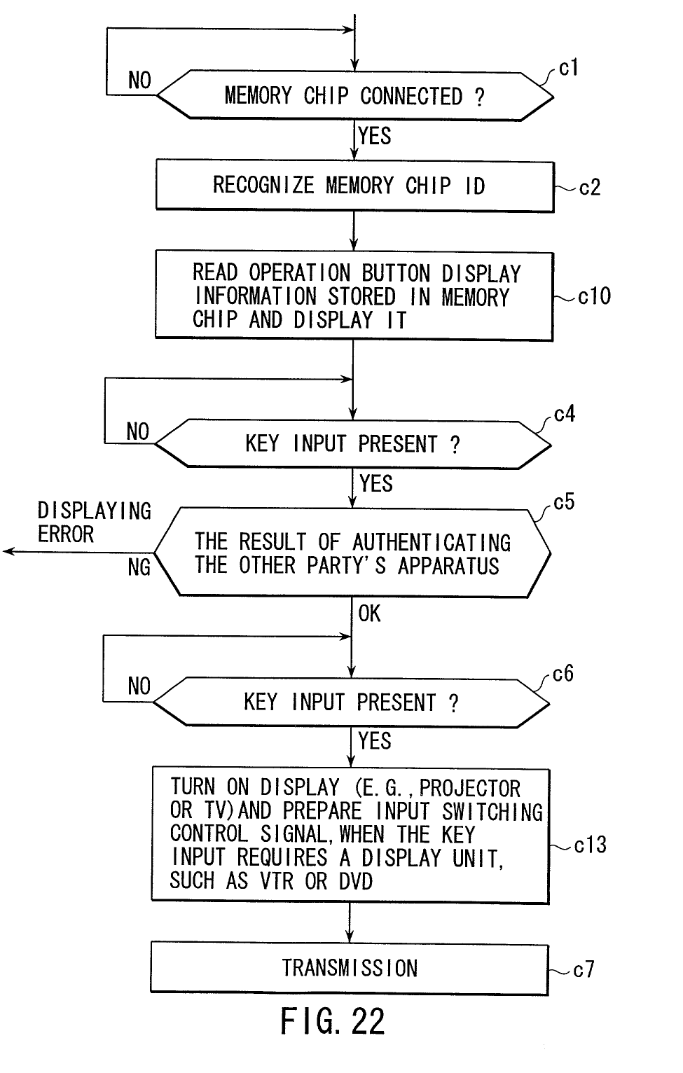

FIG. 22 is a flowchart for the operation when the IC card installed in the remote controller 10 is for remote control and deals with a device requiring display, such as a VTR or DVD. In FIG. 22, the same steps as those in the preceding embodiment are indicated by the same reference numerals. In this flowchart, the function (step) of judging the controlled object is carried out after step c6. At this step c13, it is judged whether the controlled object's display is required to be turned on, such as of a VTR or DVD. If the control signal for turning on those devices is received, the power supply for the display of each of the television set and projector will be turned on simultaneously and the switching control signal be transmitted to the input line. This enables the display to select its output automatically, even when the VTR or DVD is operated, and display the pictures.

In the explanation, the remote controller 10 has the functions of a household electrical appliance control device, portable video player, and mobile phone. Since the remote controller 10 further has the function of invalidating the use of others, it can be used as a door key control device.

A transmission/reception unit may be formed integrally with the remote controller 10 or into a separate card unit that can be installed into or removed from the remote controller. Alternatively, the remote controller 10 may be designed to accept both of these two types of transmission/reception unit. When a detachable transmission/reception unit is used, a slot for installation of the unit is made in the remote controller. A wireless terminal section for transmitting and receiving data is, of course, provided.

While the above explanation has centered around IC cards, various types of storage medium may be used. The IC cards may be memory cards, I/O cards, modem cards, or LAN cards. The memory card may be provided with a wireless terminal. There are various methods of processing image information and audio information. For instance, JPEG or MPEG formats may be used. Furthermore, transmission and reception may be performed using the base data.

The present invention is not limited to the above embodiments and, of course, may be applied to combinations of those embodiments.

As has been explained above, with the present invention, it is possible to remarkably expand the application of the IC card without increasing costs, whilst remarkably improving the use of the remote controller itself.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A remote controller for remotely controlling the operation of an electronic apparatus, comprising:
a card slot which permits installation and removal of an IC card;
reproducing means for reading data from said IC card inserted into said card slot; and
transmission means for transmitting information about the type of said IC card reproduced by said reproducing means.

2. The remote controller according to claim 1, wherein said IC card is replaced to change an electronic apparatus to be remotely controlled.

3. A remote controller for remotely controlling the operation of an electronic apparatus, comprising:
a card slot which permits installation and removal of an IC card;
reproducing means for reading data from said IC card inserted into said card slot;
recording means for recording data into said IC card; and
a transmission/reception wireless terminal section for transmitting information about the type of said IC card reproduced by said reproducing means or receiving data from said electronic apparatus.

4. The remote controller according to claim 3, wherein said IC card holds the data for controlling a television set.

5. The remote controller according to claim 3, wherein said transmission/reception wireless terminal section is provided inside said slot.

6. A remote controller for remotely controlling the operation of an electronic apparatus, comprising:
a card slot which permits installation and removal of an IC card;
reproducing means for reading image data from said IC card inserted into said card slot; and
transmission means for transmitting the image data read by said reproducing means to said electronic apparatus.

7. The remote controller according to claim 6, wherein said transmission means transmits the user data stored in said IC card to a display unit acting as said electronic apparatus.

8. The remote controller according to claim 7, wherein said IC card has stored the image data picked by a digital camera.

9. A remote controller for remotely controlling the operation of an electronic apparatus, comprising:
a card slot which permits installation and removal of an IC card;
transmission instructing means for instructing said electronic apparatus to transmit data;
a wireless terminal for responding to the transmission instruction from said transmission instructing means and receiving the data transmitted by said electronic apparatus;
recording means for recording the data received via said wireless terminal into the IC card inserted in said card slot; and
reproducing means for reproducing said data recorded in said IC card.

10. The remote controller according to claim 9, wherein said reproducing means has an audio processing section for reproducing music information.

11. The remote controller according to claim 9, wherein said reproducing means has a video processing section for reproducing video information.

12. A remote controller for remotely controlling the operation of an electronic apparatus, comprising:
a card slot which permits installation and removal of an IC card;
transmission instructing means for instructing said electronic apparatus to transmit data;
a wireless terminal for, on the basis of said transmission instruction, receiving the encrypted data; and
recording means for recording the encrypted data into the IC card inserted in said card slot.

13. A mobile phone for remotely controlling the operation of an electronic apparatus, comprising:
a card slot which permits installation and removal of an IC card;
means for reproducing a control program for controlling said electronic apparatus from the IC card inserted in said card slot;
control means for, remotely, controlling said electronic apparatus on the basis of said reproduced control program;
reception means for receiving the data transmitted on the basis of a request made by the control means, from said electronic apparatus;
recording means for recording the received data into the IC card inserted in said card slot; and
reproducing means for reproducing the data recorded in said IC card.

14. An electronic apparatus controlled by a remote controller permitting installation and removal of an IC card, comprising:
a wireless terminal for receiving the data said remote controller has stored in said IC card;
judging means for judging the type of said IC card from the data transmitted via said wireless terminal; and
reproducing means for reproducing said received data on the basis of the result of the judgment by said judging means.

15. An electronic apparatus controlled by a remote controller permitting installation and removal of an IC card, comprising:
identifying means capable of identifying the type of said IC card from the signal transmitted from said remote controller.

16. A remote control method of remotely controlling the operation of an electronic apparatus, comprising steps of:
installing an IC card into a card slot, reading and reproducing the data from said IC card inserted in said card slot, and transmitting the reproduced information about the type of said IC card to said electronic apparatus.

17. A remote control method of remotely controlling the operation of an electronic apparatus, comprising steps of:
installing an IC card into a card slot;
reading and reproducing the data from said IC card inserted in said card slot;
transmitting the reproduced information about the type of said IC card to said electronic apparatus;
receiving the data from said electronic apparatus; and
recording the received data to said IC card.

18. A control method of controlling the operation of an electronic apparatus by means of a remote controller permitting installation and removal of an IC card, said control method comprising steps of:
receiving the data transmitted from said remote controller, judging the type of said IC card from said received data, and, reproducing said received data, on the basis of the result of the judgment.
